(19) United States
(12) Patent Application Publication
(10) Pub. No.: US 2007/0078704 A1
(43) Pub. Date: Apr. 5, 2007

(54) Method and system for disseminating commercial information by mobile telephone

(76) Inventor: Thierry Demars, Lyon (FR)

Correspondence Address: CANTOR COLBURN, LLP, 55 GRIFFIN ROAD SOUTH, BLOOMFIELD, CT, 06002, US

(21) Appl. No.: 10/547,432

(22) PCT Filed: Jan. 21, 2004
(86) PCT No.: PCT/FR04/00126

§ 371 Date: Oct. 19, 2006

(30) Foreign Application Priority Data
Feb. 25, 2003 (FR) 03.02284

(51) Int. Cl. G06Q 30/00

(52) U.S. Cl. 705/14

(57) ABSTRACT

The invention enables a mobile telephone user to receive commercial information relating to the geographical position thereof on his/her telephone in the form of messages. The mobile telephone user voluntary registers with a service. Registration is received and stored in a data base. The mobile telephone user is also provided with a portable module which can be automatically detected in the closest geographical area of a terminal. Once the registration of the mobile telephone user has been verified in the data base, information is sent in the form of messages to the mobile telephone of the user and said information is displayed thereon.

The present invention relates in a general manner to methods and systems allowing the dissemination of commercial information by mobile telephone. More particularly, this invention allows the carrier of a mobile telephone to receive on his telephone, in the form of messages, commercial or similar information tied to his geographical position.

The principle of the disseminating of commercial information by mobile telephone is already known. It generally involves the arrival of commercial messages on the screen of a mobile telephone.

However, in such a system, the carrier of a mobile telephone can receive unsolicited commercial messages. Moreover, these messages retain a very general character, and relate for example to a commercial proposal valid throughout the national territory. In no case are the messages specific to the immediate geographical position of the carrier of the mobile telephone.

Additionally, geographical locating is currently done by complex methods, tied to expensive, restricted or rather limited technologies, such as the systems of the “GPS” type, of the “BlueTooth™” type or the possibilities offered with mobile telephone networks of the “GSM” type.

Patent WO9114984 relating to a device for disseminating advertisements in a shop is known from the prior art. The method requires the implementation of specific terminals coupled to a trolley, of which the information being disseminated is already present in memory. This solution is not suited to the dissemination of messages intended for existing equipment.

French patent FR2818851 relates to a method allowing the transmission of advertising messages to an undefined set of mobile telephone equipment in proximity to a facility. The method requires however in each of the mobile terminals the presence of a technical system for detecting the sending facilities and the installation of specific software. Such a solution involves a software update of the mobile telephone pool, which is difficult to achieve without the agreement of telephone operators and makers.

French patent FR2819366 relates to a system of facilities detectable by mobile telephones, as well as to a method of sending messages. This system implements a server connected to the cellular network to which the mobile telephones must belong. It is then necessary to intervene on this network, this being impossible to achieve without the agreement and the participation of the mobile telephone operator. Such a solution is not conceivable without high costs.

The present invention is aimed at remedying the drawbacks and inadequacies of the current and earlier systems, by providing a method and a system for disseminating commercial information by mobile telephone, allowing the receipt of information tied to the geographical position of the carrier of a mobile telephone, hence information of genuine proximity, while performing accurate locating of the carrier of the telephone by especially simple and economical means, without modifying the existing pool, doing so while avoiding the receipt of unsolicited messages.

To this end, the invention is firstly directed at a method of disseminating commercial information by mobile telephone, the method consisting essentially:
In respect of the carrier of the mobile telephone, in employing a portable module with a remote detection function;
In subscribing voluntarily to the service allowing the reception of commercial information;
In receiving this request for registration, in then associating it with the numbers of the portable module and of the mobile telephone and in storing these data in a database;
In detecting in an automated manner the portable module present on the carrier of the mobile telephone within a close geographical radius near to a facility allowing the detection of the portable module;
In verifying that the number of the portable module detected is present in the database and in extracting the associated mobile telephone number;
In dispatching the information, in the form of messages, to the mobile telephone concerned; and
In displaying this information on the screen of the mobile telephone.

According to the mode of implementation of the method to which the invention is directed, the voluntary registration of the carrier of the mobile telephone is done using any means making it possible to undertake the registration with the service, such as access by fixed or mobile telephone, via an Internet site, “Wap” or “I-Mode”, by minitel, by “SMS” or “MMS”, or the like.

According to the same mode of implementation of the method, the portable module possesses a unique identifier or number.

According to the same mode of implementation of the method, the detection and communication technology used between the portable module and the facility is of BlueTooth™ or equivalent type.

According to the same mode of implementation of the method, the information is returned to the mobile telephone of the carrier, in the form of messages of “SMS” type (Short Message System) or “MMS” type (Multimedia Message System.

According to the same mode of implementation of the method, the database is installed in the facility.

According to another mode of implementation of the method, the database is installed on a remote server to which the facility connects up in order to verify the presence of the number of the portable module detected.

Optionally, the message dispatched to the mobile telephone and containing the selected commercial information also contains a unique code allocated to a particular commercial promotion. This code, identifiable by the trader or the provider offering the promotion, makes it possible to avoid any improper usage (multiple usage of the same promotion, communication of the message to persons not able to benefit from the promotion, etc).

As is readily understood, the method to which the invention is directed allows the carrier of a mobile telephone to receive, automatically and quasi-instantaneously, the commercial information corresponding to his geographical position. However, according to an advantageous possibility, the mobile telephone numbers of the carriers stored may be used, so as to enable them to benefit subsequently from preferential promotions or information, again by automatic dispatching of messages to his mobile telephone.

As a whole, the method to which the invention is directed comprises the possibilities and advantages below:
This method requires storage of the telephone number of the mobile of the user, so as to obtain commercial information, thereby already avoiding the receipt of unsolicited messages, and rendering the method compatible with all legislation or regulations which demand prior agreement with communication.
This method allows the geographical locating of the carrier of the mobile telephone with practically the same level of precision as systems of the “GPS” type, but at a much lower cost and with an entirely remarkable and unique simplicity of implementation.
This method makes it possible to offer the carrier of the mobile telephone, duly located, commercial promotions or information of genuine proximity, hence of definite practical interest and relevance, such as for example: hotels, restaurants, businesses offering a promotion, nearby public transport timetables, etc, within a close geographical radius.
This method is completely controllable by the participating service providers or traders, on the one hand through the presence in the shop of facilities allowing the detection of the portable modules, on the other hand by virtue of the authentication of the promotions by a unique code, and finally through the choice of the messages to be dispatched to the mobile telephone of the carrier.
This method is compatible with the entire mobile telephone pool without requiring technical or software updating.

The invention is also directed at a system for disseminating commercial information by mobile telephone, especially designed for the implementation of the method defined hereinabove.

This system essentially comprises, in combination:
Means of reception of the registrations, sent by the carriers of the mobile telephones,
A database making it possible to associate with each registration received the number of the portable module and the mobile telephone number of the carrier,
Means of detection between the facilities and the portable modules within a close geographical radius,
Means of sending messages to the mobile telephones.

In any event, the invention will be better understood with the aid of the description which follows of modes of implementation of this method of disseminating commercial information by mobile telephone, with reference to the appended diagrammatic drawing in which:

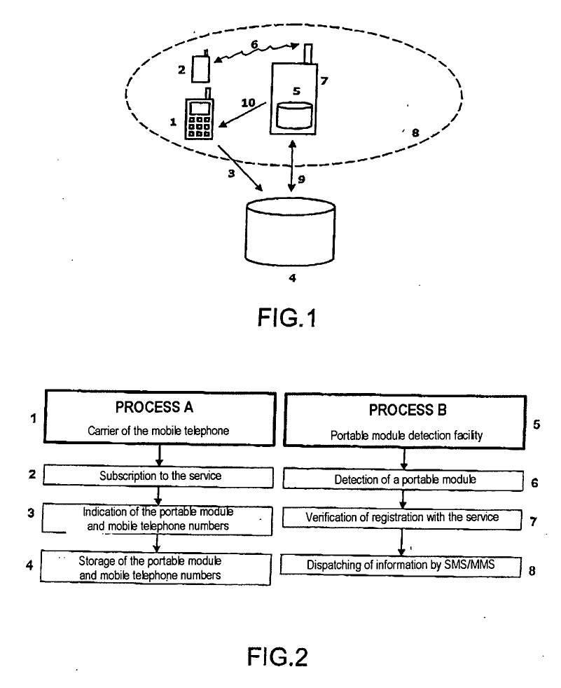

FIG. 1 is a schematic diagram of the system for implementing this method.

FIG. 2 is a flowchart illustrating the two processes of the method at which the invention is directed.

FIG. 1 is a schematic diagram of the system implementing the methods “A” and “B” of FIG. 2. In this functional diagram, the subscription to the service 3, sent by the user of the mobile telephone 1, enhances the database 4; 5, which stores the numbers of the portable module 2 and of the mobile telephone of the user 1.

The system also comprises a facility 7 which detects 6 within a close geographical radius 8 the presence of the portable module 2. This facility verifies 9 the presence of the number of the portable module detected 2 in the database 4; 5, and if need be dispatches 10 the relevant information to the mobile telephone 1.

As shown by FIG. 2, the method comprises two main processes, designated “A” and “B” respectively.

In process “A”, as indicated at 1, the user subscribes voluntarily to the service allowing him to receive commercial information tied to his geographical position, and indicates his portable module and mobile telephone numbers. After this indication, this information is stored in a database.

In process “B”, as indicated at 5, the facility present at the trader's or services provider's premises detects the portable modules present within a close geographical radius.

As indicated at 7, the verification of the presence of the number of the portable module detected in the database is then carried out. As indicated at 8, if the presence is validated, the information is dispatched, in “SMS” or “MMS” message form, to the mobile telephone of the carrier, so as to be displayed on the screen.

By way of practical example of usage, a person carrying a mobile telephone will be able to register with the service, indicate his mobile telephone number, and receive automatically when passing in proximity to a shop a message containing a promotion offer. In the same way, while waiting at a bus stop he will be able to receive a message indicating to him the timetable for the next bus.

As is self-evident, the invention is not limited solely to the processes of this method of disseminating commercial information by mobile telephone which were described hereinabove, by way of example; on the contrary, it encompasses all variants complying with the same principle. Thus, in particular, one would not be straying from the scope of the invention:
By using any other item of information, other than the mobile telephone number, making it possible to identify in a unique manner the mobile telephone of the user;
By deleting the presence of the portable module for all mobile telephone appliances already possessing the functions of the portable module;
By receiving the messages, by means of all the appliances possessing the functions of a mobile telephone;
By disseminating all sorts of commercial, promotional or practical information, pertaining to services of any nature;
By selecting and disseminating information of greater or lesser proximity, with respect to the location of the carriers.

1.-9. (canceled)

10. A method of disseminating commercial information by mobile telephone, allowing a user of a mobile telephone to receive on the telephone, in a form of messages, commercial or similar information tied to the user's geographical position, comprising:
the user employing a portable module with a remote detection function;
the user subscribing voluntarily to a service allowing reception of commercial information;
receiving this request for registration, associating it with numbers of the portable module and of the mobile telephone, and storing this data in a database;
detecting in an automated manner the portable module present on the user of the mobile telephone within a close geographical radius near to a facility allowing the detection of the portable module;
verifying that the number of the portable module detected is present in the database and extracting the associated mobile telephone number;
dispatching the information, in the form of messages, to the mobile telephone concerned; and
displaying this information on a screen of the mobile telephone.

11. The method as claimed in claim 10, wherein the voluntary subscription of the user of the mobile telephone comprises the indication of the number of the detectable module and of the mobile telephone number.

12. The method according to claim 10, wherein the user of the mobile telephone must carry the portable module detectable by the facility.

13. The method according to claim 10, wherein the message containing the commercial information dispatched to the mobile telephone also contains a unique code allocated to a particular commercial promotion.

14. The method according to claim 10, wherein the telephone number of the user stored is used so as to subsequently enable the user to benefit from preferential promotions or information, again by automatic dispatching of messages to the mobile telephone.

15. A system for disseminating commercial information by mobile telephone and for the implementing the method according to claim 1, the system comprising:
means for receiving the registrations sent by the users of the mobile telephones;
a database to associate with each registration received the number of the portable module and the mobile telephone number of the user;
means for detection between facilities and the portable modules within a close geographical radius; and
means for sending messages to the mobile telephones.

16. The system according to claim 15, wherein the database is a database which associates the number of the portable module and the mobile telephone number.

17. The system according to claim 16, wherein the database is installed on each detection facility.

18. The system according to claim 16, wherein the database is installed on a remote server to which the facility connects up in order to verify a presence of the number of the portable module detected.
